(19) United States
(12) Patent Application Publication
(10) Pub. No.: US 2024/0200923 A1
(43) Pub. Date: Jun. 20, 2024

(54) Masonry Square

(71) Applicant: KAPRO INDUSTRIES LTD, Bikat Beit Hakerem (IL)

(72) Inventor: Steven FECHINO, Hendersonville, TN (US)

(21) Appl. No.: 18/543,802

(22) Filed: Dec. 18, 2023

(30) Foreign Application Priority Data
Dec. 18, 2022 (IL) 299218

(51) Int. Cl. G01B 3/56

(52) U.S. Cl. CPC G01B 3/566

(57) ABSTRACT

A masonry square for assisting a mason to align and level modular brick courses and oversize brick courses with uniform mortar height between brick courses. The masonry square includes a generally isosceles right angle body having a base, a top surface, a bottom surface, a standard inch rule, a notched slot opposite the standard inch rule, and a marking PIVOT at its right angle point and 5° to 90° protractor angles in 5° increments along its hypotenuse opposite the PIVOT marking. The masonry square combines a modular spacing rule for use with modular bricks for commercial construction, an oversized brick spacing rule for use with oversized bricks for residential construction, and a standard brick spacing rule or a brick mason's rule for use with both modular bricks and oversized bricks for uniformly modifying the preferred ⅜″ mortar height between brick courses.

### CROSS-REFERENCE TO RELATED APPLICATION(S)

The present application claims priority to Israel patent application No. 299218 filed on Dec. 18, 2022, the entire content of which is incorporated by reference herein.

### FIELD OF THE INVENTION

The invention relates to a device to assist in the laying of brick courses.

### BACKGROUND OF THE INVENTION

Masons are required to align and level brick courses and to preferably ensure uniform mortar height between adjacent brick courses as they are successively laid on top of the other. Preferred uniform mortar height is ⅜″. Brick sizes can be generally classified into two types: so-called modular bricks typically employed for commercial construction and so-called non-modular or oversized bricks (hereinafter referred to as oversized bricks) typically employed for residential construction. Reference is made to The Brick Industry Association, Technical Notes on Brick Construction, Dimensioning and Estimating Brick Masonry, published 10 Feb. 2009, incorporated herein by reference. Particular reference is made to FIG. 2 Modular Brick Sizes (Nominal Dimensions) showing a wide range of brick sizes and FIG. 3 Non-modular Brick Sizes (Specified Dimensions) showing a smaller range of brick sizes than modular brick sizes. The difference between nominal dimensions and specified dimensions is explained on Page 2 of 11: Brick Dimensions paragraph.

A mason's toolbag includes a wide range of different handtools for assisting to lay brick courses including inter alia a so-called modular spacing rule for use with modular bricks for commercial construction, a so-called oversized brick spacing rule for use with oversized bricks for residential construction, a standard brick spacer rule or a brick mason's rule for use with both modular bricks and oversized bricks, a speed square, a tape measure, a spirit level, and the like.

The modular spacing rule, the oversized brick spacing rule, and the standard brick spacing rule are typically folding rules of about 8″ increments and having a total length of 6′. The modular spacing rule and the oversized brick spacing rule have a standard inch rule on one side and their corresponding spacing rules on their reverse side. The standard brick spacer rule or a brick mason's rule has a standard inch rule on one side and rulings on its reverse side for assisting a mason to modify mortar height between brick courses to ensure a uniform mortar height between all brick courses.

A speed square also called a rafter square, a rafter angle square, and a triangle square is a multi-purpose carpenter's tool for marking purposes. The speed square has a generally isosceles right angle body with two sides and a hypotenuse. One side is formed with a base and the other free side has a standard inch rule. A speed square includes an elongated ½″ notched slot opposite the standard inch rule for enabling a carpenter to mark long lines spaced from an edge on sliding the speed square down the edge with the base pressed thereagainst. A speed square is marked with the word PIVOT at the right angle point and 5° to 90° protractor angles in 5° increments along its hypotenuse opposite the word PIVOT.

There is a need to assist masons to align and level brick courses with less handtools.

### SUMMARY OF THE INVENTION

The present invention is directed towards a masonry square specifically designed to meet a mason's needs to align and level modular brick courses and oversized brick courses with uniform mortar height between brick courses. The masonry square is similar to a carpenter's speed square and accordingly includes a generally isosceles right angle body having a base, a top surface, a bottom surface, a standard inch rule, a notched slot opposite the standard inch rule, and a marking PIVOT at its right angle point and 5° to 90° protractor angles in 5° increments along its hypotenuse opposite the PIVOT marking. Additionally, the masonry square of the present invention combines a modular spacing rule for use with modular bricks for commercial construction, an oversized brick spacing rule for use with oversized bricks for residential construction, and a standard brick spacing rule or a brick mason's rule for use with both modular bricks and oversized bricks for uniformly modifying the preferred ⅜″ mortar height between brick courses.

The modular spacing rule, the oversized brick spacing rule, the standard brick spacing rule and the standard inch rule can be deployed in four deployments as follows: A modular spacing rule is deployed along a base on one surface of either a top surface or a bottom surface and an oversized brick spacing rule is deployed along the base on the other surface of the top surface or the bottom surface. A standard brick spacing rule is deployed along a free side on one surface of either a top surface or a bottom surface and a standard inch rule is deployed along the free side on the other surface of the top surface or the bottom surface.

The top surface and the bottom surface are preferably printed with conversion tables related to their respective modular spacing rule and oversized brick spacing rule.

The masonry squares of the present invention can be readily modified for use with metric sized bricks as opposed to imperial sized bricks

### BRIEF DESCRIPTION OF DRAWINGS

In order to understand the present invention and to see how it can be carried out in practice, preferred embodiments will now be described, by way of non-limiting examples only, with reference to the accompanying drawings, in which similar parts are likewise numbered, and in which:

FIG. 1 is a top perspective view of a masonry square in accordance with a first embodiment of the present invention;

FIG. 2 is a top plan view of the FIG. 1 masonry square;

FIG. 3 is a bottom plan view of the FIG. 1 masonry square;

FIG. 4 is a bottom perspective view of a masonry square in accordance with a second embodiment of the present invention;

FIG. 5 is a bottom plan view of the FIG. 4 masonry square; and

FIG. 6 is a top plan view of the FIG. 4 masonry square.

### DETAILED DESCRIPTION OF DRAWINGS

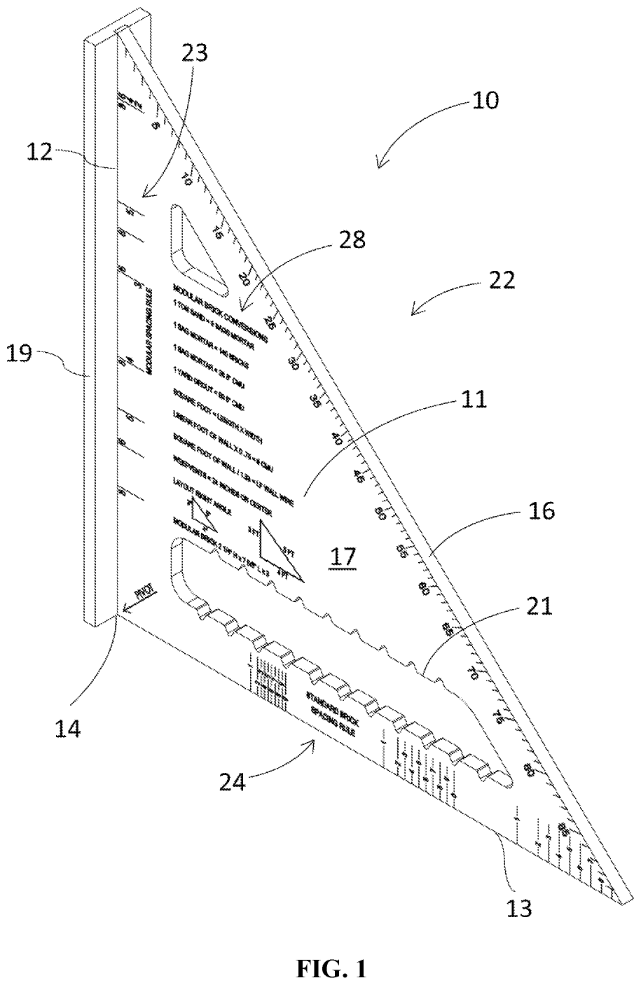

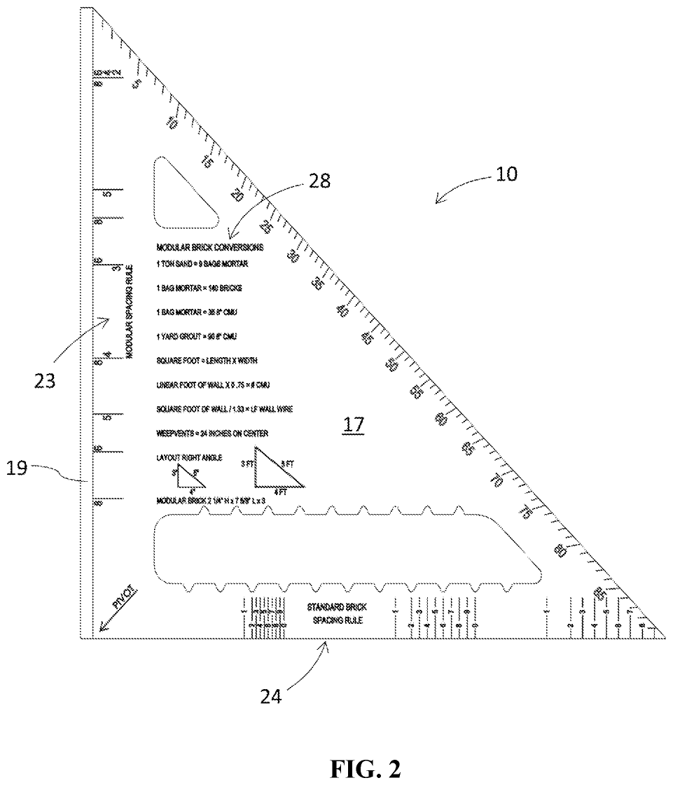

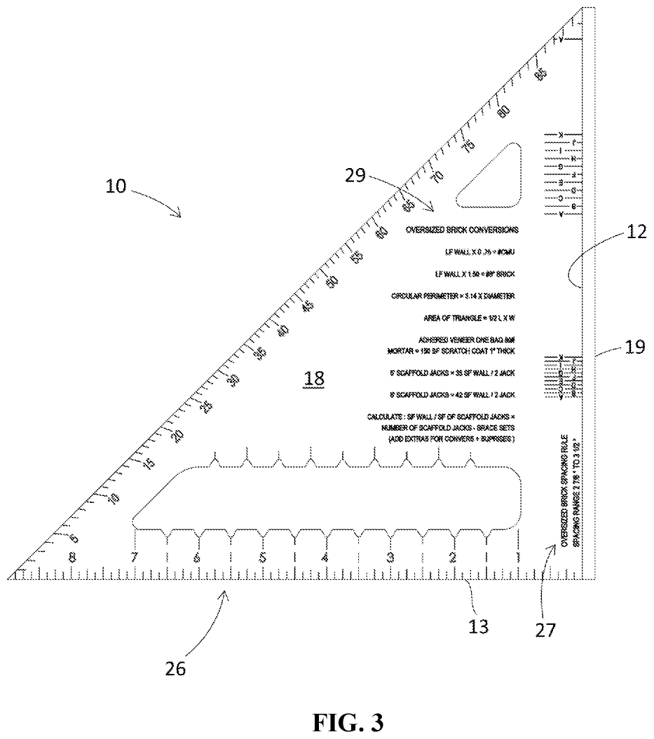

FIG. 1 to FIG. 3 show a masonry square 10 for use with modular bricks for commercial construction and oversized bricks for residential construction. The masonry square 10 includes a generally 9″ isosceles right angle body 11 with two sides 12 and 13 meeting at a right angle 14, a hypotenuse 16 opposite the right angle 14, and a top surface 17 and a bottom surface 18. The masonry square 10 is made from metal, durable plastic, and the like.

The side 12 is formed with a base 19 and the body 11 is formed with an elongated 2″ notched slot 21 opposite the side 13.

The top surface 17's right angle 14 is marked PIVOT and the top surface 17's and the bottom surface 18's hypotenuse 16 are both marked with a 5° to 90° protractor angles 22 in 5° increments.

The top surface 17 includes a modular spacing rule 23 along the base 19 and a standard brick spacing rule 24 along the side 13 such that a mason working with modular bricks can conveniently use them during construction without having to flip over the masonry square 10 each time he wants to use one or the other.

The bottom surface 18 includes a standard inch rule 26 along the side 13 for use with the notched slot 21 and an oversized brick spacing rule 27 along the base 19.

The top surface 17 includes a modular brick conversion table 28 with useful modular brick conversions to assist a mason laying modular bricks.

The bottom surface 18 includes an oversized brick conversion table 29 with useful oversize brick conversions to assist a mason laying oversize bricks.

Following measurement of the height of an intended brick wall and determination of the number of brick courses and uniform mortar height, a mason uses the masonry square 10 for laying modular bricks in a comparable manner to a conventional modular spacing rule and a conventional standard brick spacing rule. Similarly, a mason uses the masonry square 10 for laying oversized bricks in a comparable manner to a conventional oversized brick spacing rule and a conventional standard brick spacing rule.

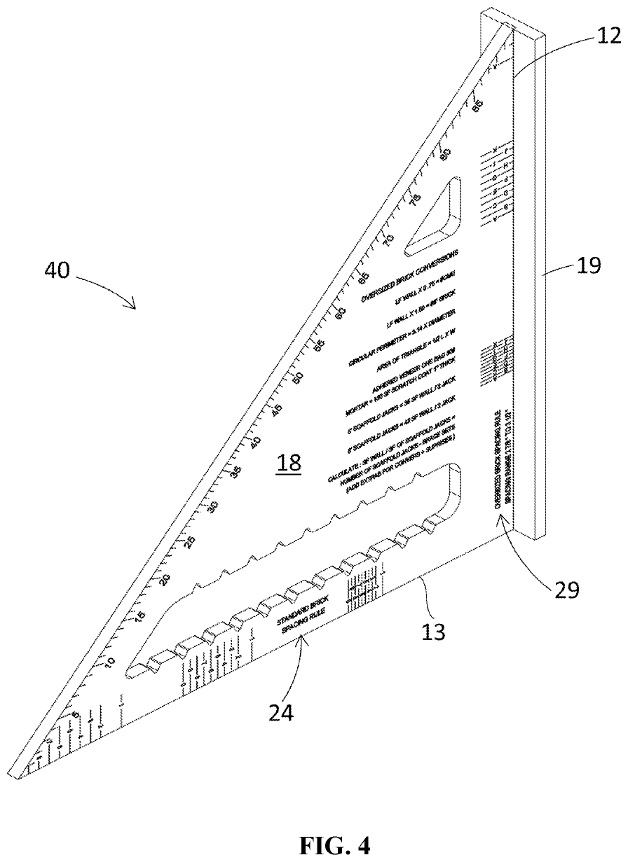

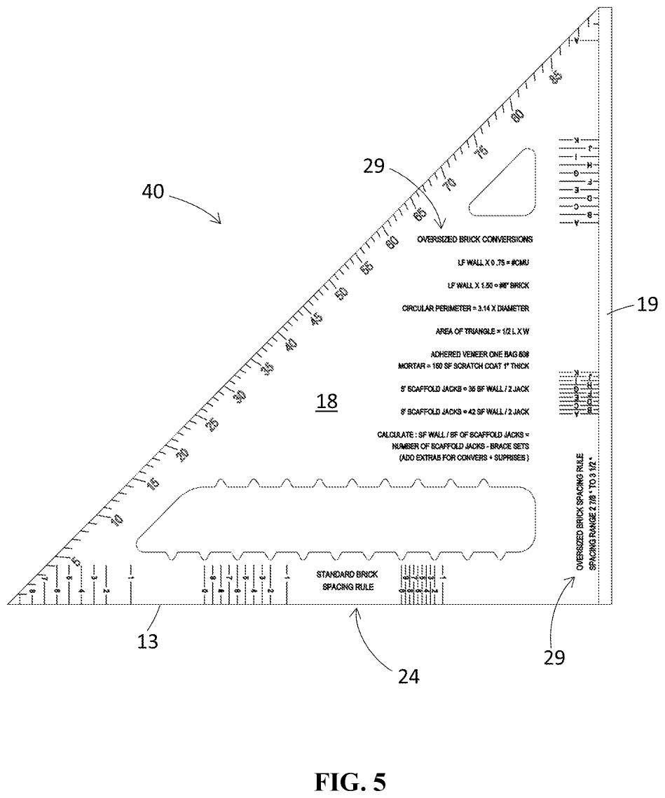

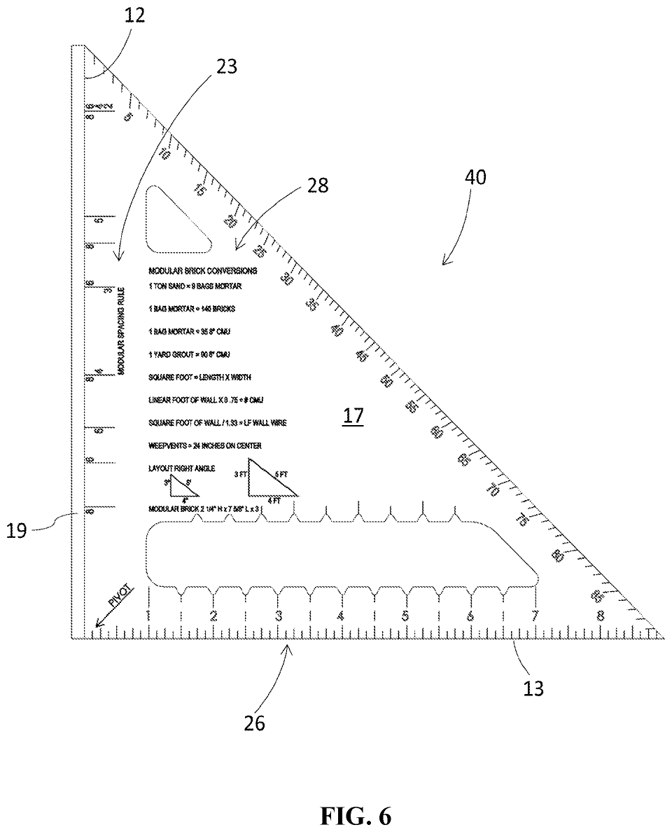

FIG. 4 to FIG. 6 show a masonry square 40 having the same construction as the masonry square 10 and therefore similar parts are likewise numbered. The masonry square 40 differs from the masonry square 10 insofar as its top surface 17 includes the standard inch rule 26 along the side 13. Accordingly, its bottom surface 18 includes the standard brick spacing rule 24 along its side 13.

In two additional embodiments of a masonry square in accordance with the present invention, the deployments of the modular spacing rule 23 and the oversized brick spacing rule 27 along the base 19 can be interchanged on the masonry square 10's top surface 17 and bottom surface 18 and similarly on the masonry square 40's top surface 17 and bottom surface 18.

While the invention has been described with respect to a limited number of embodiments, it will be appreciated that many variations, modifications, and other applications of the invention can be made within the scope of the appended claims.

1. A masonry square for use with modular bricks and oversized bricks, the masonry square comprising:
a generally isosceles right angle body with two sides meeting at a right angle and a hypotenuse opposite said right angle, and a top surface and a bottom surface,
a side of said two sides is formed with a base,
said body is formed with an elongated notched slot along the other side of said two sides,
said top surface includes a marking PIVOT at said right angle,
said top surface and said bottom surface are both marked with protractor angles along said hypotenuse,
a modular spacing rule deployed along said base of one surface of said top surface and said bottom surface and an oversized brick spacing rule deployed along said base on the other surface of said top surface and said bottom surface, and
a standard brick spacing rule deployed along said other side of said two sides on one surface of said top surface and said bottom surface and a standard rule deployed along said other side of said two sides on the other surface of said top surface and said bottom surface.

2. The masonry square according to claim 1 wherein said top surface includes said modular spacing rule and said standard brick spacing rule.

3. The masonry square according to claim 1 wherein said top surface includes said modular spacing rule and said standard rule.

4. The masonry square according to claim 1 wherein said top surface includes said oversized brick spacing rule and said standard brick spacing rule.

5. The masonry square according to claim 1 wherein said top surface includes said oversized brick spacing rule and said standard rule.

6. The masonry square according to claim 1 for use with imperial sized bricks.

7. The masonry square according to claim 1 for use with metric sized bricks.
